(19) United States
(12) Patent Application Publication
(10) Pub. No.: US 2025/0269382 A1
(43) Pub. Date: Aug. 28, 2025

(54) MATERIAL SHREDDER WITH GRINDING DEVICE, SHREDDING UNIT AND MAINTENANCE METHOD

(71) Applicant: Johannes Wissing, Stadtlohn (DE)

(72) Inventor: Johannes Wissing, Stadtlohn (DE)

(21) Appl. No.: 19/184,165

(22) Filed: Apr. 21, 2025

Related U.S. Application Data
(63) Continuation of application No. PCT/EP2023/079336, filed on Oct. 20, 2023.

(30) Foreign Application Priority Data
Oct. 21, 2022 (DE) 102022127958.8

(51) Int. Cl. B02C 18/18; B02C 23/02; B02C 23/08; B02C 25/00

(52) U.S. Cl. CPC B02C 18/186; B02C 23/02; B02C 25/00; B02C 23/08; B02C 2210/01

(57) ABSTRACT

A material shredder is provided for shredding recyclable materials. The shredder includes a rotor with multiple cutting blades arranged around its outer surface. These blades have cutting edges that form a cutting circumference. The rotor is enclosed by a housing, creating a cutting chamber between the rotor and stator. Inside this chamber, the cutting blades interact with at least one counter blade mounted on the inner surface of the stator, spaced to form a cutting gap. The stator also includes at least one outlet with a screen that helps define the cutting chamber. The shredder further includes a grinding device with an abrasive holder, located outside the cutting circumference. Both the abrasive and the screen can be moved to adjust their distance from the cutting circumference. The invention also includes a shredding plant with the shredder and a method for maintaining the shredder.

### BACKGROUND INFORMATION

### Field of the Invention

The invention relates to a material shredder according to the features in the preamble of claim 1, which is specified to shred material to be cut, in particular (recyclable) material to be cut, such as waste material, (fiber-containing) plastics materials, or the like. The material to be cut, or material to be shredded, can comprise interfering materials, for example silica-containing materials or similar. Moreover, the material to be cut is not uniformly oriented when the latter is fed to the material shredder.

### Discussion of Prior Art

Generic shredders, in particular granulators or the like, have been known for a long time. Shredders of this type always have a cutting head which is upright or horizontal and rotatably drive, wherein the term cutting head herein is used collectively for a rotor in the form of a drum, a roller or the like, or for a rotor which has one or a plurality of rotor blades. A multiplicity of shredding tools, in particular cutting blades, are typically disposed on the cutting head, wherein the cutting edges of the cutting blades form a cutting circumference when the cutting head rotates. In the cutting region, thus in the outer circumference of the cutting circumference, the cutting blades can comprise different materials, for example tungsten carbide or the like.

The cutting head is at least in portions surrounded by a rotor housing which herein is referred to as a stator. The stator surrounds the rotatably mounted cutting head, wherein one static counter blade, or preferably a plurality of static counter blades, is/are disposed on the inner circumference of the stator. The stator is typically designed as an at least partially cylindrical housing which delimits the space surrounding the rotor, also referred to as the cutting chamber. The material to be cut is shredded in the cutting gap which is formed as a radial spacing between the cutting edge and the counter blade.

Material to be cut is able to be introduced into the cutting chamber through an inlet in the stator, and the shredded material is able to be discharged from the cutting chamber through an outlet in the stator (due to the centrifugal force). Conveyor apparatuses which force the material to be cut to be actively fed, i.e. push the material to be cut partially into the cutting circumference, are known. In a particularly simple embodiment, the inlet can be identical to the outlet. A conveyor apparatus and/or a collection device can be provided so as to adjoin the outlet, in order to be able to convey or collect the shredded material, respectively. A (perforated) screen which is disposed in the outlet and delimits the cutting space in terms of size serves to establish the typically fine particle sizes for the shredded material discharged from the cutting chamber in such a manner that the material to be cut is shredded until it passes through the screen. Screen sizes up to approx. 100 mm are in particular widely used. In conjunction with the counter blade, the screen has the effect that the material to be cut is to some extent cut multiple times, wherein the material to be cut in the process is fundamentally not subjected to any defined orientation in the cutting chamber.

The cutting blades and counter blades of a material shredder are stressed in many ways during shredding, in particular in the case of silica-containing deposits or the like on the material to be cut. The edge radius of the blades, i.e. the radius on the cutting edge which is achieved by two converging surfaces of the blade, which is decisive for shredding, increases as the wear and tear progresses, whereby the required shredding required correspondingly increases, for example. The wear on the cutting edges moreover has the effect of enlarging the cutting gap. This results in a drop in the cutting quality, or the cutting consistency, because the material to be cut is increasingly squashed and/or torn apart, whereby an unwanted dust content having very small particle sizes in the material to be cut correspondingly increases.

In order to nevertheless be able to guarantee a sufficient homogenous cutting consistency while using a moderate energy input, and in order to be able to convey the material to be cut reliably through the screen, it is necessary to regularly sharpen the cutting blades, on the one hand, and optionally also the counter blades, i.e. to reduce the cutting edge radius. On the other hand, the counter blades in particular have to be readjusted in order to be able to keep the cutting gap largely constant in the context of an adequate cutting consistency.

DE 865 249 B discloses a generic material shredder, wherein it is proposed for improving the cutting consistency that the cutting blades and the counter blades are disposed at an angle to the rotation axis, and at a mutual angle, so as to be able, in the fashion of tangential cutting, to effect shredding of the material to be cut in the manner of scissors. Correspondingly, the helical design of the cutting blades according to the invention is said to be problematic in terms of the regrinding of the cutting blades It is now a customary practice to dispose the blades in such a manner that the material to be cut is shredded by means of tangential cutting, so as to reduce the stress on the blades, or to prolong the service life cycles, respectively. Also, it is well known to provide the cutting edges with particularly hard surfaces or the like, so as to be able to prolong the service life cycles.

Ultimately, however, the known material shredders have in common the issue that regrinding of the cutting blades and/or counter blades is associated with an economically disadvantageous material shredder downtime, because the blades have to be removed in order to be able to grind the latter, which is time-intensive, personnel-heavy and prone to errors. Any downtime is in particular disadvantageous in that the material shredder typically represents a central piece of equipment within a larger processing unit, so that the entire processing unit is unproductive during maintenance of the material shredder. In the course of the removal of the blades and the installation of the blades it is furthermore necessary to carefully clean the blade holders in which the blades are releasably fixed, so that no residue remains, which could lead to a fixed blade cracking or breaking, in particular in the event of a non-uniform force-fit when clamping the blades, or could cause an increased stress acting on portions the cutting edge during the cutting procedure.

### BRIEF SUMMARY OF THE INVENTION

The present invention is based on the object of proposing a material shredder which can be operated in an economically advantageous manner with longer service life cycles without compromising the cutting consistency, i.e. the cutting quality, or without a higher energy input being required for shredding material to be cut, in particular recyclable waste material, (fiber-containing) plastics materials, or the like.

The object is achieved by a material shredder according to the feature of claim 1, by a shredding plant according to the features of claim 15, and by a method as claimed in claim 18.

Features of the device will be described hereunder. These design features can be implemented in conjunction with the invention, or else be inventive in their own rights, independently of the invention, and they can be implemented either individually and independently of one another, or else in any arbitrary combination, including the implementation of all of the features mentioned unless a combination is precluded expressively or due to technical incompatibility.

In other words, the invention proposes a device for shredding material to be cut, or material to be shredded, specifically a material shredder. Relevant to the invention is a grinding device which enables the cutting blades on the cutting head, in particular the cutting edge, to be able to be ground during the rotation of the cutting head, so that a prolonged material shredder downtime can be economically advantageously avoided, because a comparatively high cutting consistency, i.e. a high cutting quality, can be guaranteed even without removing the cutting blades. Also, the risk of a blade failure is reduced, because the clamping of a blade after grinding is not always manually performed. Furthermore, as a result of the rotation during grinding, and ideal geometric, substantially cylindrical, cutting circumference can be achieved in such a way that the cutting edges of a plurality of cutting blades are in each case circumferentially disposed on the same circular path.

According to the proposal, the grinding device is disposed outside the cutting circumference, preferably radially outside the cutting circumference, by way of a grinding medium receptacle holding a grinding medium. The grinding medium receptacle can have a grinding disk, a grinding medium support or the like, which are connected to the grinding medium, wherein the grinding medium is particularly preferably releasably connected to the grinding medium receptacle, for example by means of an adhesively bonded, an adhesive, a latching, or a plug connection, or the like, so as to be able to relatively easily replace the grinding medium as the grinding medium wear progresses. According to the invention, the grinding medium in terms of its position is movable, so that the latter is movable selectively from a resting position without a grinding effect, in which the grinding medium is disposed outside the cutting circumference, to a closer grinding position with a grinding effect, in which the grinding medium is engaged with the cutting edges of the cutting blades, and preferably causes a substantially tangential beveling of the cutting edges toward the cutting circumference, thus sharpening of the cutting blades.

The screen, which can occupy a substantial circumferential portion of the stator, is according to the invention likewise movable in terms of position in such a manner that the cutting chamber, and thus the spacing of the cutting circumference from the screen, is variable in size. As the material removal increases during the regrinding of the cutting blades, the spacing of the screen from the cutting circumference is fundamentally enlarged. This is problematic to the extent that the cutting blades also serve to force the material to be cut through the screen if the material to be cut is able to pass through the screen. As the spacing between the screen and the cutting circumference increases, the material to be cut is increasingly subjected to squashing, and the required energy for driving the cutting head increases. As a result of the mobility of the screen in terms of its position, these disadvantages can surprisingly be avoided, and the stresses acting on the material to be cut can be reduced.

It can be provided that one screen, or a plurality of screens which is/are movable in terms of position are disposed. Furthermore, a screen can in each case be substantially integral or be formed in segments, so that a plurality of screen elements form one screen. The screen elements in the outlet can be mutually aligned so as to be angular. Alternatively, the screen elements can be arcuate at least in portions, so that a plurality of screen elements achieve a larger arc.

In one design embodiment, the grinding device can have a guide, for example in the manner of a guide rail, a guide track, or the like. Particularly preferable is a linear guide which is advantageously aligned substantially parallel to the longitudinal axis or rotation axis of the cutting head, and the grinding medium receptacle is disposed on the linear guide so as to be displaceable along the cutting blades, specifically displaceable so as to be effective for grinding. For example, a grinding slide, a grinding carriage or the like, which is mounted on running rollers and connects the grinding medium receptacle in a displaceable manner to the linear guide, can be disposed on the guide rail. The linear guide with a grinding slide serves to be able to guide a grinding medium back and forth, in the manner of a reciprocating movement, so as to be effective for grinding, along the longitudinal axial extent of the cutting blades. Scratches in the cutting edges of the cutting blades can be avoided due to the reciprocating grinding, for example. Moreover, the cutting blades can be reground very uniformly so as to generate a cutting circumference which is homogenous over the cutting blade length. The region within which the grinding medium engages with the cutting blades is presently referred to as a grinding zone.

The grinding slide, the grinding carriage, or the like is advantageously driven mechanically, hydraulically, pneumatically or electrically, for example by means of a chain belt drive, a tow rope drive, or the like.

In a very simple design embodiment, the grinding medium can be held co-rotationally on the grinding medium receptacle in a grinding medium holder In a preferred refinement, the grinding medium holder can rotatably hold the grinding medium so that the grinding medium is preferably rotatable about a rotation axis which is aligned so as to be substantially perpendicular to the cutting head rotation axis. The grinding medium holder can be designed in the manner of a cup wheel, for example. The grinding medium herein can be disposed on a cross-sectional face, and is rotatably driven by way of the grinding medium holder, so that the grinding medium during the reciprocating movement rotates in and/or counter to the rotating direction of the cutting head. The rotating speed of the grinding medium is preferably slower than the rotating speed of the cutting head.

As an alternative to the cup wheel, the grinding medium receiving means can have a rotationally driven grinding medium wheel which is aligned substantially parallel to the rotational axis of the cutting head and at least to the circumference of which an grinding medium is disposed so that an grinding medium can be rotated either with or against the rotational direction of the cutting head.

The rotation of the grinding medium can in each case relate to one complete rotation, or a plurality of complete rotations, about the only rotation axis, and the cutting blades are sharpened during this rotation of the grinding medium. It can likewise be provided that the grinding medium rotates in each case discontinuously about an arc, so that the cutting blades are at least temporarily ground by an non-rotating grinding medium. Partial rotations by 3 to 270°, particularly preferably 5 to 30°, are advantageous herein. Any (partial) rotation of the grinding medium is presently referred to as a rotation. It can furthermore be provided that the grinding medium rotates outside and/or within the grinding zone.

For a design embodiment of the positional mobility of the grinding medium, the grinding device can particularly advantageously have a grinding medium actuator, specifically preferably on the linear guide, the grinding medium receptacle and/or the grinding medium holder. During actuation, a grinding medium is moved selectively toward the cutting edge of the cutting blade, or the radial spacing of the grinding medium from the cutting head is reduced, respectively. In order to increase the effectiveness of the grinding medium, it can be sufficient to rotate the grinding medium in such a way that it these portions of the grinding medium are brought closer to the cutting circumference, or brought to engage with the cutting blades, respectively. An actuation for a grinding effect, i.e. an actuation when there grinding medium in the grinding zone engages with the cutting circumference, is presently referred to as operational grinding, or fine grinding, whereby grinding without actuation is referred to as sparking.

It can be provided that the grinding medium actuation serves to move the grinding medium from a spaced-apart resting position to a grinding position with a grinding effect and/or more over to be able to define the intensity of the material removal during grinding, wherein the actuation is preferably infinitely variable. For this purpose, the actuator can have one actuation screw, or a plurality of actuation screws, for example, by way of which the radial spacing can be adjusted. Alternatively or additionally, hydraulically or pneumatically driven cylinders, or the like, can be provided in order to actuate the grinding medium, or to move the grinding medium to the resting position, respectively.

A particularly inventive refinement can relate to a nozzle unit on the grinding device. One or a plurality of preferred suction nozzles, suction ports, or the like, presently collectively referred to a suction nozzles, serve to be able to discharge potential grinding dust directly from the grinding zone. For this purpose, the suction nozzles are aligned relative to the cutting circumference for a suction effect, meaning that the suction effect of the suction nozzle extend substantially up to the cutting circumference The nozzle unit is advantageously fluidically connected to a collection unit in which the grinding dust is collected. It can be prevented in this way that grinding dust contaminates the material to be shredded Alternatively or additionally, application nozzles, which, for example, feed a cooling fluid or the like to the cutting circumference, can be provided.

In a further design embodiment, the screen can be pivotably held, specifically preferably parallel to the rotation axis of the cutting head, so that the screen can be pivotable out of the outlet in order to be able to expose the latter, so that the cutting head, or the stator, is easy to clean, on the one hand. On the other hand, the pivotable mounting can enable that the radial spacing of the screen from the cutting head, and thus the size of the cutting chamber, is selectively adjustable in the manner of a screen actuation. A screen arrangement of this type is advantageous in order to be able to guarantee a largely homogenous spacing between the cutting circumference and the screen, so that an economically efficient energy input for the drive of the cutting head, and only minimal effects on the material properties of the material to be cut, for example on the elastic-mechanical strength, are able to be implemented in association therewith.

A screen holder, which is pivotably mounted and on which an adjustment device acts, the latter being disposed outside the cutting chamber, can be provided for adjusting the spacing and for fixing the screen. Advantageously, the adjustment device can have an actuating pin which is held so as to be substantially movable, preferably in an infinitely variable manner, in the radial direction, and which is connected to the screen holder, and which defines the approach of the screen to the cutting circumference. Alternatively or additionally, a pneumatically or hydraulically driven cylinder, or the like, can be provided, by way of which a pivoting range of the screen holder, or of the screen, is adjustable.

Usually, the screen can have a substantially rectangular shape, which is curved so as to correspond to the diameter of the cutting head, or of the stator, respectively, wherein the screen in this case is held so as to be pivotable by way of a non-curved longitudinal side. It can be provided that the screen on one end side, specifically on the opposite longitudinal site, in a peripheral region of the screen, presently referred to as a transition zone, has a tapered material thickness that decreases in the cross section, and that the stator and the screen are disposed so as to overlap one another at least in the transition zone, wherein the screen herein in is disposed radially inside. The material thickness preferably decreases in the rotating direction of the cutting head, so that material to be cut does not undesirably catch in the cutting chamber, or the like. The tapered overlap of screen and stator in the transition region facilitates a screen actuation which is adapted to the material removal caused by grinding.

A refinement of the invention can have a control unit which was signal transmission is connected to the grinding device, in particular to the grinding medium actuator, so that a degree of actuation is preferably able to be adjusted by a program. Alternatively or additionally, the control unit can feedback-control the reciprocating movement by which the grinding medium is guided along the cutting blades. An operating element by way of which an operator can define an actuation, or an actuation program, respectively, is advantageously linked to the control unit. Alternatively or additionally, sensors which detect the drive output of the cutting head, or the like, can be provided, so as to be able to therefrom draw conclusions pertaining to the wear on the cutting blades, and to be able to initiate regrinding of the cutting edges, specifically in an automated manner. For this purpose, the control unit can preferably be designed for controlling the rotation of the cutting head.

In a particular advantageous inventive design embodiment, the stator can have, outside the cutting circumference, one, or a plurality of, punctiform and/or linear directing elements in the manner of protrusions, cams, guide ribs, lips or similar, which protrudes/protrude radially into the cutting chamber. The directing elements can serve to align the material to be cut, in particular fragments of film, film strips or the like, during the rotation of the cutting head. Consequently, among other things, the migration of the material to be cut on the screen is reduced, and the cutting consistency and the discharge of the material to be cut from the cutting chamber is improved, so that the cutting edges of the cutting blades are subjected to less stress, and the service life cycle of a material shredder can consequently be prolonged. For a particularly advantageous design embodiment it can be provided that directing elements are disposed on the screen.

An indicator for detecting the wear on the cutting edges can be the material to be cut, once the latter has an exit that the cutting chamber. In the case of advanced wear, the material to be cut typically displays fibrous, lacerated coating surfaces. Furthermore, the dust content, i.e. the content of comparatively small particles of material to be cut. Therefore, in one refinement, an optical detection of the material to be cut can be provided, for example a camera, which detect substantial features such as the geometry of the material to be cut, the surface properties, or the like, and preferably evaluates said features based on software. If the detected actual value excessively deviates from a memorized target value, an alarm signal which, for example, draws the attention of a user to the need for regrinding can be emitted. Alternatively, an alarm signal can be transmitted to the control unit, the latter initiating regrinding in an automated manner.

Alternatively or additionally, the dust content in the outlet flow can be detected electrically, for example by means of resistance measurement, or by means of screening methods, wherein the dust content is first separated and the weight of the dust content is then determined. As has already been indicated above, sensors which detect the power consumption of the drive unit for the cutting head can be provided, where in an increased power consumption of the drive unit typically indicates an advanced wear on the cutting edges. In response to cutting edge wear which has been established or derived, respectively, a grinding procedure which has been initiated by a user, or particularly preferably automated by means of a control unit, can be performed.

An acoustic sensor, for example in the manner of a knock sensor, which is specified to detect the sound of relations which are created when a cutting blade moved past the counter blade, can be particularly advantageous, wherein the dimension of the cutting gap generating each case a characteristic acoustic signal which is generally, or in sensory terms, perceptible as a knocking sound. In this way, a conclusion pertaining to the wear on the cutting edges can be drawn in a simple manner, and if required be responded to by regrinding, either manually or in an automated manner as described above.

An acoustic sensor in the manner of a knock sensor, or the like, can alternatively or additionally in particular serve to determine a spacing of the grinding medium from the cutting circumference. This spacing can be important when activating the grinding medium, for example. If the actuation is performed too rapidly, or if the engagement of the grinding medium in the grinding circumference is excessive, there is the risk of damage to the material shredder.

In one design embodiment, the material shredder can have a metal sensor which identifies metallic constituent parts in the material to be cut. Constituent parts of this type are advantageously detected before they are fed to the cutting chamber, so as to be able to prevent any damage, for example. For this purpose, the metal sensor can be connected to the control unit, which stops the feed of the material to be cut into the cutting chamber, and/or which stops the cutting head, when metal constituent parts are detected

A substantial element for the cutting consistency is, among other things, the size of the cutting gap between the cutting circumference and the counter blade. Advantageously, a blade holder can be provided in which a counter blade is releasably fixed on the stator, wherein the blade holder is movable relative to the cutting head, so that the counter blades are able to be moved close to the cutting circumference, preferably in an infinitely variable manner. Particularly preferably, regardless of the refinement of the blade holder, the material shredder can presently have at least two counter blades. Preferably, the blade holder can be adjustable in a motorized manner, for example by means of a linear motor with an adjusting spindle, wherein the drive for signal transmission is preferably connected to the control unit for automated adjustment of the cutting gap. Preferably, the counter blade is held in the blade holder in a clamping manner, for example by means of disk springs and/or hydraulic compression. In the context of an extended service life cycle, manual adjustment can thus be dispensed with. In particular, in order to enable manual readjustment of the counter blades, the blade holder can have adjustment screws for defining the cutting gap.

In a refinement of the invention, a blade holder can each have so-called blade seats for a plurality of counter blades, wherein a counter blade in a blade seat is preferably fixed by screws, and the blade holder is rotatably mounted in such a way hat a first blade seat with counter blade can be aligned either in an operating position, creating a cutting gap, or in a resting position. In this way, the set-up times can be significantly reduced by allowing a first counter blade to work in the operating position, while a second counter blade of the blade holder can be serviced, in particular ground.

In a particularly advantageous design embodiment, alternatively or additionally to the nozzle unit, a suction device can be provided, which is connected to the outlet, specifically having a suction flow effect, so that the material to be cut from the cutting chamber can be suctioned through the screen into the outlet and finally, for example, into a collection device. The suction system supports continuous removal of material to be cut from the cutting chamber, so that the material to be cut can be shredded with a high cutting consistency and that, for example, blockages or the like can be avoided in the cutting chamber or in the screen.

Moreover, a suction device can be advantageous in order to be able to suction grinding dust during a grinding procedure, whereby, for example, contamination of the material to be cut can be avoided when the cutting head is rotated and the cutting blades are ground, but no material to be cut is located in the cutting chamber. In one refinement, a suction device can be provided, which suctions the grinding dust directly from the grinding medium. For this purpose, for example, a suction nozzle provided on the grinding device can be provided, which is connected to the suction device with an effective suction flow. By disposing a filter in the suction flow, or the like, a separation of the grinding dust from the suction flow can be carried out, so that in principle shredding of the material to be cut can take place during grinding without the material to be cut being contaminated. This makes it economically advantageous to extend the service life cycle of the material shredder.

A particularly preferred embodiment having one or more of the features described herein relates to a material shredder in the form of a granulator. Granulators are used in particular to provide particularly fine material fractions after cutting, namely advantageously having a maximum edge length substantially less than 100 mm, preferably substantially in the range from 20 to 100 mm, particularly preferably substantially less than 20 mm.

It is furthermore proposed to provide a shredding plant of waste materials with a shredding device, which is a material shredder, in particular a granulator, having the features according to the proposal, and optionally having the features according to the previously described refinements, or the like. The shredding plant proposed moreover has a feeding apparatus which transfers the material to be cut, for example, in the manner of a funnel arrangement or the like, into the material shredder, without material to be cut being substantially lost. Furthermore, the shredding plant can advantageously have a discharge apparatus which conveys the material shredder by the material shredder, for example by means of conveyor screw, slide, air flow or the like.

In one design embodiment, the shredding plant can have at least one container for material to be cut, into which the shredded material to be cut is conveyed upon passing through the screen.

A refinement can advantageously provide a metering apparatus which is disposed on the feeding apparatus, in order to be able to introduce the material to be cut into the cutting chamber as required. Firstly, this can prevent blockages or the like in the cutting chamber. Secondly, the feeding of the material to be cut can be configured in such a manner that an optimal utilization of the drive output of the cutting head can be implemented, for example by way of a homogeneous load situation. Thirdly, a substantially homogeneous drive output can help to detect wear on the cutting blades at an early stage and to be able to respond as required, for example by grinding.

Fourthly, a kind of buffer storage can be created by a metering apparatus, in particular when an interval-like feeding with material to be cut is provided, for example by means of industrial trucks, wheel loaders or the like.

Advantageously, a conveyor apparatus can be provided, which forms a conveying section which opens into the feeding apparatus. Material to be cut can be conveyed and fed continuously to the greatest extent possible by means of a conveyor apparatus. In this context, the conveyor apparatus can also or in particular function as a metering apparatus for a demand-tailored supply of material to be cut.

The invention further relates to a maintenance method for a material shredder, in particular for (re) establishing an operability of the material shredder, wherein an grinding medium is actuated toward a cutting edge of a cutting blade, the grinding medium is guided along the cutting blade, and a screen is actuated tower the cutting head, wherein the cutting head rotates at least during grinding. Preferably, the material shredder has one or a plurality of the previously described features.

In the context of actuation, a grinding medium, as described above, from a grinding ineffective arrangement is brought to engage with a cutting edge of a cutting blade, wherein the cutting blade is disposed so as to extend axially on a rotatably mounted rotor, referred to as cutting head, of the material shredder, on the one hand. As soon as the grinding medium is engaged with the cutting edge, material can be removed from the cutting edge to reduce the cutting edge radius. On the other hand, the material removal can be defined by means of actuation, in such a way that with increasing actuation, meaning, that the grinding medium is moved radially closer to the cutting head, a larger material removal is achieved, especially at the cutting edge.

According to the proposal, the grinding medium for a grinding effect is guided along the cutting blades, preferably multiple times back and forth in the manner of a reciprocating movement, wherein it is decisive that the cutting head rotates in the process. Because the cutting edges are able machined, i.e. able to be ground, during rotation of the cutting head, the service life cycle of a material shredder can be extended in an economically advantageous manner. It is no longer necessary to disassemble the cutting blades prior to grinding and then to install the sharpened cutting blades in a costly manner. Furthermore, the rotation during grinding achieves an ideal geometric, substantially cylindrical shape of a cutting circumference, so that the cutting edges of a plurality of cutting blades are in each case disposed circumferentially on the same circular path.

According to the proposal, the spacing of a screen from the cutting head, or from the cutting blade, is reduced, wherein the screen is disposed in an outlet of the stator. By reducing the spacing, it is ensured upon grinding of the cutting blades that the material to be cut continues to be conveyed through the screen, guaranteeing a constant cutting consistency. The actuation of the screen can be performed substantially simultaneously with the grinding procedure.

In a refinement of the method, a radial actuation of one or a plurality of counter blades can be provided, which is/are disposed on the inner circumference of the stator surrounding the cutting head, so that a substantially constant cutting gap between counter blade and cutting edge can be implemented. Since material is removed from the cutting edges during grinding, it can be necessary to adjust the radial spacing between the counter blade and the cutting blade or cutting head, respectively. A largely constant cutting gap helps to extend the service life cycle of the cutting blades, so that maintenance costs can be reduced and the service life cycles can be extended.

The present invention is based on the concept of proposing an economically advantageous solution. Extensive automation can make a significant contribution to this. In a particularly inventive refinement, the process steps can therefore be performed so as to be feedback-controlled, i.e. mutually coordinated and particularly preferably automatically. In a control unit, a signal which induces increased cutting edge wear, in that an actual value deviates from a target value, is first evaluated. The power consumption of the cutting head and/or the cutting quality or the dust content, or the like, can be used as indicators for increased cutting edge wear. If increased wear is detected, grinding of the cutting blades is initiated by the control unit. For this purpose, the control unit controls the actuating of the grinding medium as well as the guiding of the grinding medium along the cutting blades. Grinding is suspended as soon as a desired cutting quality is achieved again and/or after the cutting blades have been ground on the basis of a known grinding experience, whereby, for example, a certain number of reciprocating movements and/or a specific grinding duration can be decisive. Due to the fact that the grinding takes place during the rotation of the cutting head, whereby the speed of the rotation of the cutting head rotation can be feedback-controlled accordingly, a cutting grade or quality can be directly verified, without costly installation and/or removal work of the cutting blades.

The grinding dust is particularly advantageously suctioned during grinding. For this purpose, it can be provided that the control unit can feedback-control a suction device or the like. Furthermore, the control unit can initiate the application of coolant or similar to cool the cutting blades during grinding.

Furthermore, it can preferably be provided that the control unit feedback-controls the actuation of the counter blades as a function of the grinding intensity. For this purpose, the control unit can process a signal from which the grinding-related material removal can be derived. On the other hand, it can be provided that the control unit processes a signal from which the spacing between the counter blade and the cutting circumference can be derived.

Alternatively or additionally, the feedback-control of the maintenance steps can follow a predetermined (time) interval, wherein the individual process steps are particularly preferably feedback-controlled by means of a control unit.

Advantageously, it can be provided that the counter blade is ground, in particular manually ground, before an actuation of the counter blade takes place.

It can be provided that the method steps described are carried out in sequence. It can likewise be provided that some or all of the method steps are at least partially carried out simultaneously. For example, the radial actuation of the grinding medium can take place (step a), while the cutting blades are ground (step b). Furthermore, the radial screen actuation (step c) can take place while the grinding medium is actuated and/or the grinding medium grinds the cutting blades. The counter blade actuation (step d) can begin or be completed after completing steps a) to c) or during one of steps a), b) or c).

An exemplary embodiment of the invention will be explained in more detail with reference to the purely schematic illustration below, wherein individual features or a combination of features of the embodiments illustrated can also be implemented independently of the remaining embodiment of the respective embodiments in a material shredder according to the proposal, or in a shredding plant, respectively.

### BRIEF DESCRIPTION OF THE DRAWINGS

FIG. 1a shows a first exemplary embodiment of a shredding plant in cross section.

FIG. 1b shows the first exemplary embodiment of a shredding plant in cross section with a detailed view of a subsection of 1a.

FIG. 1c shows the first exemplary embodiment of a shredding plant in cross section with a detailed view of a subsection of 1a.

FIG. 2 shows a perspective view from obliquely above onto a grinding device of the exemplary embodiment of FIG. 1a;

FIG. 3 shows detailed perspective view of the grinding device from FIG. 2 from obliquely below;

FIG. 4 shows a perspective view of the exemplary embodiment from FIG. 1a;

FIG. 5 shows another exemplary embodiment of an opened shredding plant in a perspective view from obliquely above;

FIG. 6 shows a cross section of the exemplary embodiment from FIG. 5; and

FIG. 7 shows a cross section of the exemplary embodiment from FIG. 5 in the closed state.

### DETAILED DESCRIPTION OF THE INVENTION

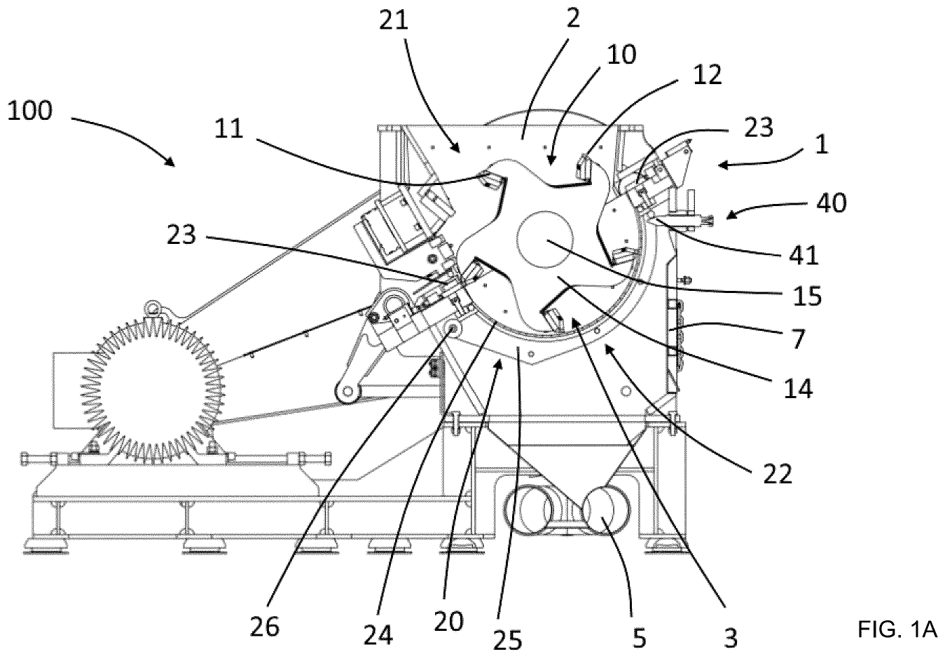

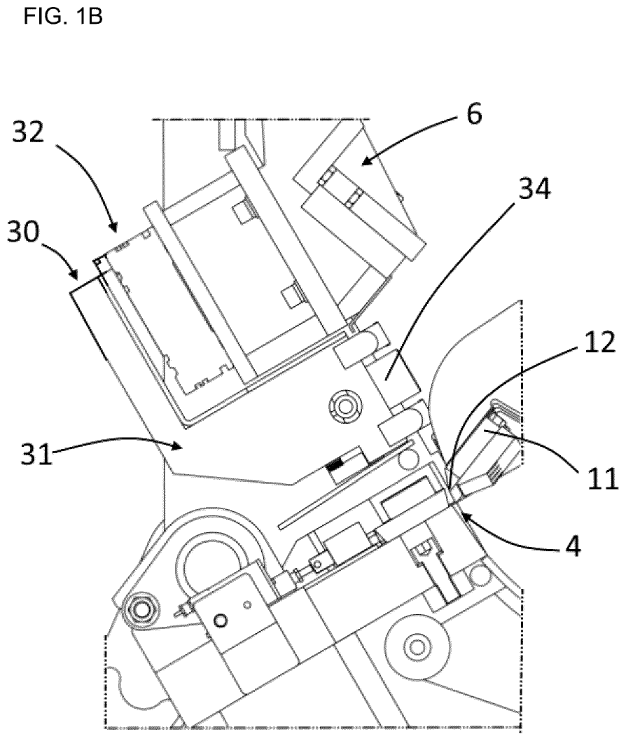

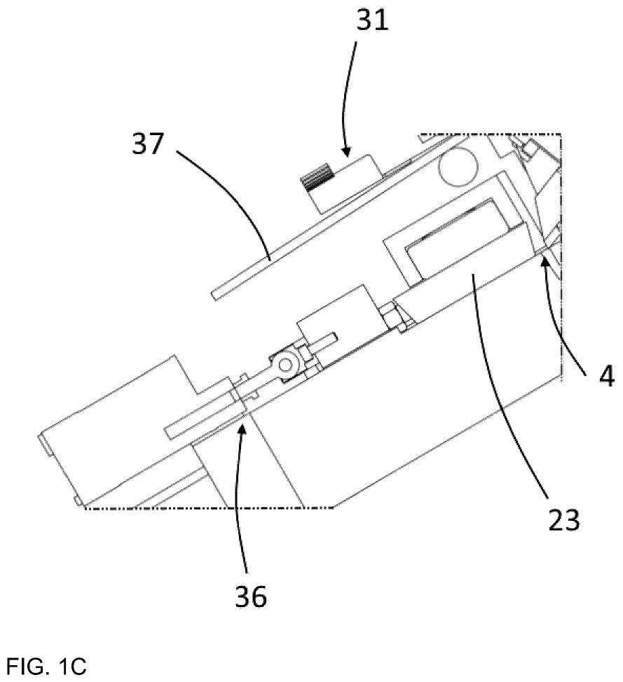

FIGS. 1A-1C show a first exemplary embodiment of a shredding plant 100 in cross section with a material shredder 1 and with a feeding apparatus 2. On a rotor shaft 15, several rotor blades 14 are disposed so as to form the rotor referred to as cutting head 10, which is horizontally aligned and rotatably mounted and which is driven, by way of example, by means of an electric motor. The cutting head 10 surrounds a rotor housing designated as stator 20, wherein the cutting head 10 and the stator 20 delimit a cutting space 3 therebetween, in which the material to be cut is shredded. The stator 20 has an inlet 21, into which the funnel-like feeding apparatus 2 opens, in order to be able to introduce the material to be cut into the cutting chamber 3. The stator 20 furthermore has an outlet 22, in which a (perforated) screen 24, hereinafter referred to as screen 24, is disposed, which allows only sufficiently shredded material to be cut, which is sufficiently shredded and thus able to pass the screen, to pass through. The material to be cut exiting from the screen 24 enters a conveyor apparatus 5, which conveys the shredded material for further processing (not shown in the drawing). A selectively openable service flap 7 allows access to the cutting chamber 3.

The cutting head 10 in FIG. 1a has a plurality of axially extending cutting blades 11 spaced apart in the circumferential direction, having radially outer cutting edges 12 which form a cutting circumference. A plurality of counter blades 23, which protrude into the cutting chamber 3 and which form a cutting gap 4 with a radial spacing to the cutting blades 11 (FIG. 1b), are disposed on the inner circumference of the stator 20. With increasing wear of the cutting blade 11 on the cutting edge 12, or with increasing cutting edge radius, the cutting gap 4 increases (see also FIG. 1c).

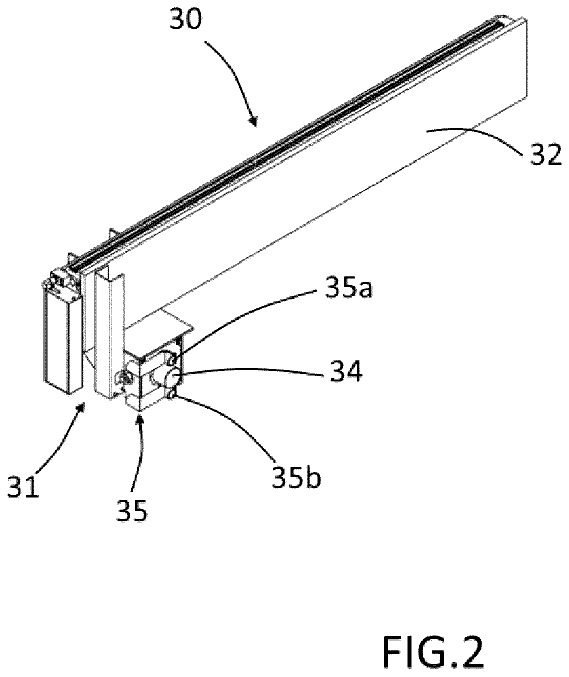

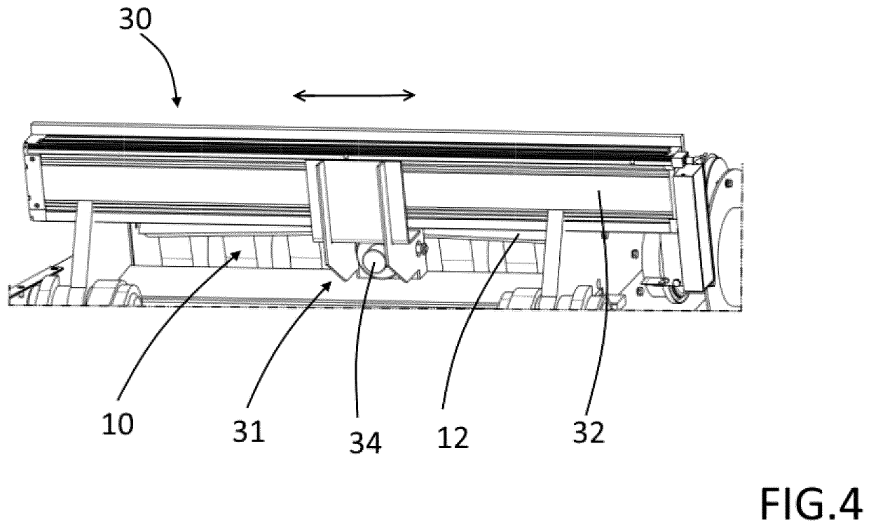

FIG. 1b shows in enlarged detail in particular a grinding device 30, which has a carriage-like grinding medium receptacle 31 and which is disposed outside a cutting circumference of the cutting blade 11. The grinding medium receptacle 31 is guided along a linear guide 32 (see also FIGS. 2 and 4). A deflector wedge 6 prevents, in particular, bulky material to be cut from being inadvertently jammed or wedged in the shredding plant, so that the risk of a malfunction can be reduced. By engaging the grinding pin 34 with the cutting edges 12, the cutting edge radius can be reduced.

The counter blade 23 is connected to a linear motor with adjusting spindle 36 so as to be movable in terms of its position (FIG. 1c), so that the counter blade 23 can be actuated in a largely automated manner, specifically as a function of the material removal due to grinding. Furthermore to be seen, in particular in FIG. 1c, is a flap 37, which is open during grinding of the cutting edges 12. In contrast, this flap 37 can be selectively closed if no grinding procedure is provided to close an opening in the stator 20 in order to prevent any loss of material to be cut.

The screen 24 in FIG. 1a is disposed in the outlet 22, wherein the screen 24 occupies a substantial part in the circumference of stator 20 surrounding the cutting head 10, and is fixed so as to be movable in terms of its position in a screen holder 25. The screen holder 25 is pivotable by way of a pivot mounting 26, wherein the pivot axis is aligned in the axial direction of the cutting head 10, in order to be able to adjust the radial spacing of the screen 24 from the cutting head 10 or to the cutting circumference, respectively.

An adjustment device 40, having an actuating pin 41, which in particular by means of a control dial causes a radial actuation of the screen 24 toward the cutting circumference in such a manner that the spacing between the screen 24 and the cutting blade 11, or the cutting circumference, respectively, is adjustable is disposed so as to act on the screen holder 25 in FIG. 1a. Even with increasing, grinding-related material removal at the cutting edge 12, the spacing between the cutting circumference and screen 24, which is relevant for the cutting consistency and for the drive energy requirement, can thus be kept largely constant and optimized, for example, as a function of the material to be cut.

A perspective view from obliquely above onto a grinding device 30 of the exemplary embodiment from FIG. 1 is shown in FIG. 2. An grinding medium receptacle 31 is held in a carriage-like manner along a linear guide 32, so that the grinding pin 34 can be guided along the cutting edges 12. The grinding medium receptacle comprises, among other things, a nozzle unit 35, wherein an application nozzle 35a is disposed above the grinding pin 34 and a suction nozzle 35b is disposed below the grinding pin 34. During grinding, a cooling fluid is applied by means of the application nozzle 35a. The suction nozzle 35b serves to enable direct suctioning of the grinding dust, in order to prevent contamination of the material to be cut.

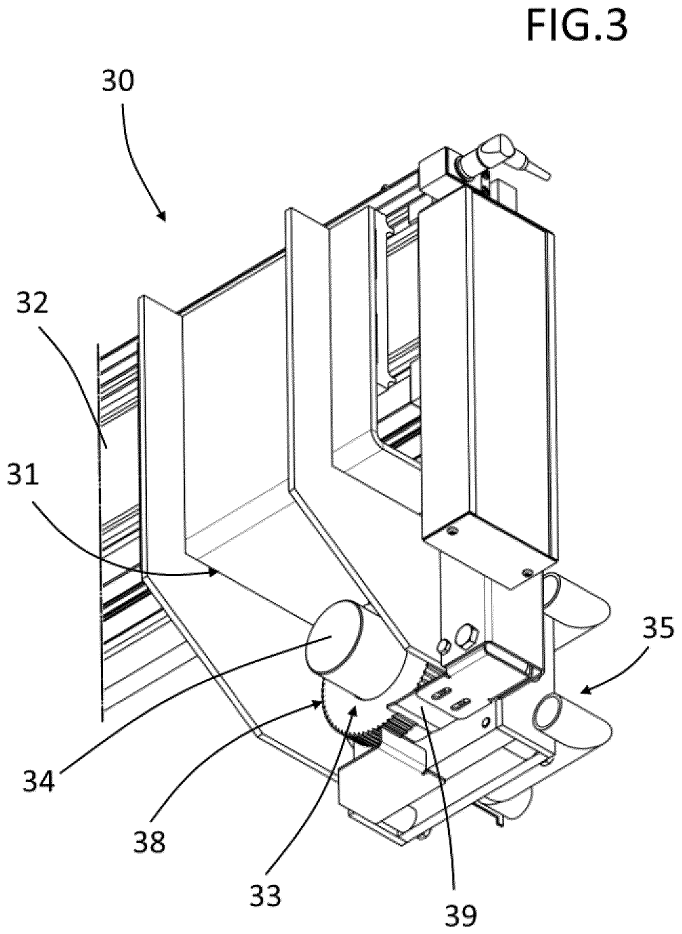

FIG. 3 shows a perspective detailed view of the grinding device 30 from FIG. 2 from obliquely below. The grinding pin 34, which is held in an grinding medium holder 33, can be seen. A gear rim 38 on the circumference of the grinding medium holder 33 interacts with a spring clip 39, in such a manner that the grinding medium holder 33 allows the grinding pin 34 to rotate exclusively in one direction and always by a radian measure in the manner of a partial rotation, which corresponds to the length of a tooth base or a multiple thereof. Each partial rotation causes an actuation of the grinding pin 34, meaning a movement of the grinding pin 34 closer to the cutting circumference, or to the cutting edges 12 of the cutting blade 11, respectively. The actuation herein is preferably carried out in the grinding zone by rotating the cutting head 10, which causes operational grinding.

A perspective view of fragments of the exemplary embodiment from FIG. 1 is shown in FIG. 4. The linear guide 32 is fixed so as to be stationary and aligned parallel to the longitudinal extent of the cutting blades 11. In the manner of a reciprocating movement, indicated in the drawing by means of a double arrow, the grinding medium receptacle 31 is moved back and forth during the grinding operation along the linear guide 32 and thus along the cutting blade 11, while the grinding pin 34 is engaged with the cutting edges 12.

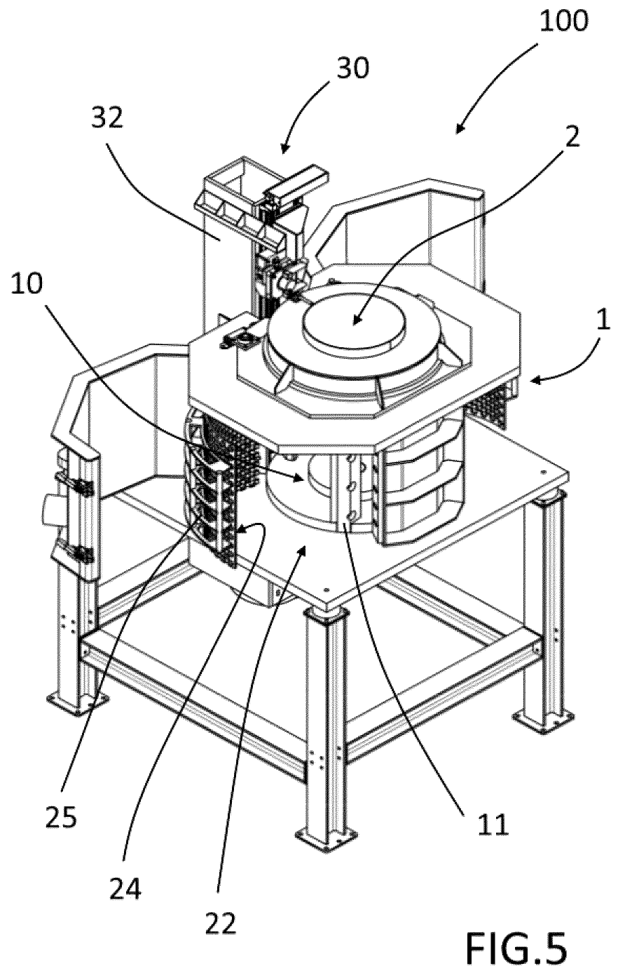

Another exemplary embodiment of a particularly compact solution of a shredding plant 100 shows FIG. 5 in perspective view from obliquely above. In the present case, the shredding plant 100 is shown in an opened state, that is, in particular, two screens 24 are pivoted upward and each expose an outlet 22, wherein for reasons of illustration only one outlet 22 is visible (see also FIG.

6). In contrast to the first exemplary embodiment, the cutting head 10 is now vertically aligned. The material to be cut is fed parallel to the rotation axis of the cutting head via the feeding apparatus 2 from above. A further difference is that not one, but two screens 24 are provided, which are each pivotably held in a screen holder 25. Parallel to the rotational axis of the cutting head 10, the linear guide 32 of the grinding device 30 is aligned.

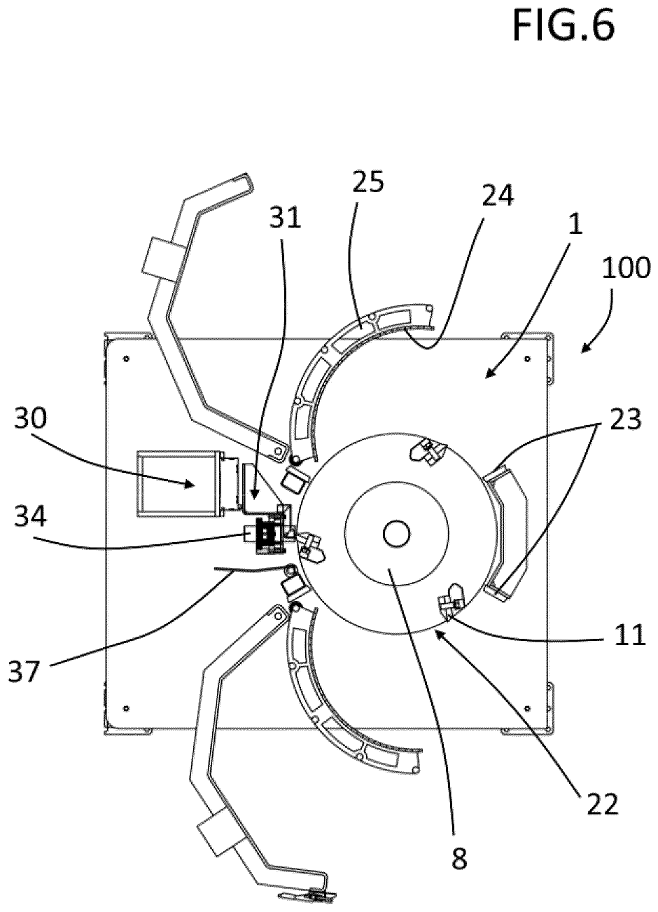

In FIG. 6, the exemplary embodiment from FIG. 5 is shown in cross section. The flap 37 is shown opened, so that the grinding of the cutting edges 12 of the cutting blade 11 is possible by means of the grinding pin 34. A feeding cone 8 on the cutting head 10 causes, among other things, that the material to be cut is guided outwards to the rotating cutting blades 11. The cutting blades 11 interact with the counter blades 23 and cause the material to be cut to be shredded.

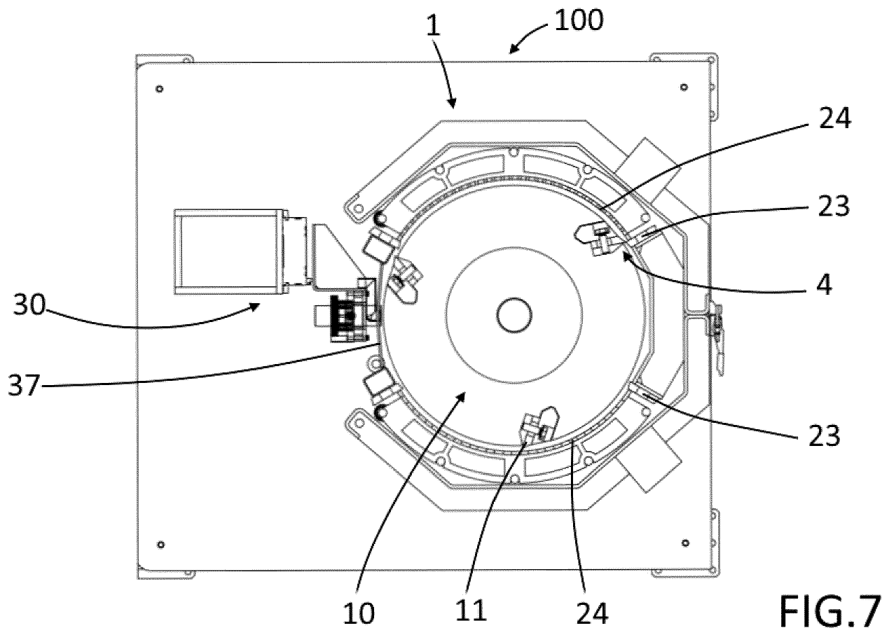

The exemplary embodiment from FIGS. 5 and 6 is shown in FIG. 7 in a closed state in cross section. On the one hand, the flap 37 is shown closed, so that the grinding device 30 cannot be operated in this configuration. On the other hand, the screens 24 are shown closing the outlets 22. The cutting blades 11 of the cutting head 10 can also be seen, which conjointly with the counter blades 23 define the cutting gap 4.

By way of example, a maintenance method is explained hereunder, especially for an application in the event that the cutting blades 11 have advanced wear.

In the process, a grinding medium is brought to engage with a cutting circumference formed by a cutting edge 12 of a cutting blade 11, in that a grinding medium is actuated toward a cutting blade 11, meaning that the radial spacing between the grinding medium and the grinding edge 12 is reduced until the grinding medium is in contact with the grinding edge 12. Depending on a further actuation of the grinding medium after the first contact between the grinding medium and cutting edge 12, the degree of material removal on the cutting blade 11 is defined.

Starting already before or even during the infeed, the grinding medium is guided along a cutting blade 11, which is disposed axially extending on the cutting head 10, wherein the cutting edge 12 is preferably ground over the entire length of the cutting blade 11 and in the manner of a reciprocating movement several times. It is essential that the rotatably mounted cutting head 10 rotates in the process. The grinding medium is preferably held on the cross-sectional face of a cup wheel, wherein the cup wheel also rotates, while the grinding medium is guided back and forth in a reciprocating movement along the cutting edge 12.

In the context of the exemplary maintenance procedure, a screen 24, which is disposed in an outlet 22 of the stator 20, is furthermore radially actuated in that the radial spacing of the screen 24 from a cutting blade 11 is reduced.

After grinding the cutting blade 11, or already during this time, the counter blades 23, which are disposed on the inner circumference of the stator 20, are actuated in that the radial spacing between the cutting blade 11 and the counter blade 23 is reduced, so that a specific spacing, referred to as the cutting gap 4, is set. If a counter blade 23 also has advanced wear, the counter blade 23 is also ground prior to actuation. The operating steps of the maintenance method are feedback-controlled by means of a control unit, so that an optimized and largely automated maintenance can be carried out.

### LIST OF REFERENCE SIGNS

1 Material shredder
2 Feeding apparatus
3 Cutting chamber
4 Cutting gap
Conveyor apparatus
6 Deflector wedge
7 Service flap
8 Feeding cone
Cutting head
11 Cutting blade
12 Cutting edge
14 Rotor blade
Rotor shaft
Stator
21 Inlet
22 Outlet
23 Counter blade
24 Screen
Screen holder
26 Pivot mounting
Grinding device
31 Grinding means receptacle
32 Linear guide
33 Grinding means holder
34 Grinding pin
Nozzle unit
35a. Application nozzle
35b. Suction nozzle
36 Linear motor with adjustment spindle
37 Flap
38 Gear rim
39 Spring clip
Adjustment device
41 Actuating pin
100 Shredding plant

1. A material shredder (1), in particular for shredding recyclable material to be cut, having a rotatably mounted rotor, referred to as a cutting head (10),
on which are disposed a plurality of axially extending cutting blades (11) which are mutually spaced apart in the circumferential direction and have radially outer cutting edges (12) which form a cutting circumference, having a rotor housing, referred to as a stator (20), which substantially surrounds the cutting head (10);
wherein the stator (20) and the cutting head (10) delimit a cutting chamber (3) which is disposed therebetween and into which the cutting blades (11) and at least one counter blade (23), disposed on the inner circumference of the stator (20), protrude;
wherein the counter blade (23) is disposed so as to be radially spaced apart from the cutting circumference so as to form a cutting gap (4); and
wherein the stator (20) has at least one outlet (22) in which a screen (24), which delimits the cutting chamber (3), is disposed,
characterized in that
the material shredder (1) has a grinding device (30) having a grinding device receptacle (31) which holds a grinding means,
wherein the grinding device (30) is disposed outside the cutting circumference; and
in that the grinding means and the screen (24) in terms of their position are movable in such a manner that the respective radial spacing from the cutting circumference is selectively adjustable.

2. The material shredder (1) as claimed in claim 1,
characterized in that
the grinding device (30) has a linear guide (32), and the grinding means receptacle (31) is disposed on the linear guide (32) so as to be displaceable along the cutting blades (11).

3. The material shredder (1) as claimed in claim 1,
characterized in that
the grinding means receptacle (31) has a grinding means holder (33) which rotatably holds the grinding means in such a manner that the grinding means is rotatable about a rotation axis which is aligned so as to be substantially perpendicular to the rotation axis of the cutting head (10).

4. The material shredder (1) as claimed in claim 1,
characterized in that
the grinding device (30) has a grinding means actuator which is specified to selectively adjusted the radial spacing of the grinding means from the cutting head (10).

5. The material shredder (1) as claimed claim 1,
characterized in that
the grinding device (30) has a nozzle unit (35), wherein at least one suction nozzle (35b) is aligned relative to the cutting circumference for a suction effect and/or one application nozzle (35a) is aligned relative to the cutting circumference for an application effect.

6. The material shredder (1) as claimed in claim 1,
characterized in that
the screen (24) pivotably held so as to be coaxial with rotation axis of the cutting head (10), and in that disposed outside the cutting chamber (3) is an adjustment device (40) which acts on the screen (24) in such manner that the radial spacing of the screen (24) from the cutting head (10), and thus the size of the cutting chamber (3), is selectively adjustable.

7. The material shredder (1) as claimed in claim 1,
characterized in that
the screen (24) on one end side, in a peripheral region of the screen (24) referred to as a transition zone, has a material thickness that decreases in cross section, and in that the stator (20) and the screen (24) are disposed so as to overlap one another in the transition zone, wherein the screen (24) herein is disposed radially inside.

8. The material shredder (1) as claimed in claim 1,
characterized by
a control unit which for signal transmission is connected to the grinding device (30).

9. The material shredder (1) as claimed in claim 1,
characterized in that
a directing element protruding radially inward into the cutting chamber (3) is disposed on the stator (20) outside the cutting circumference.

10. The material shredder (1) as claimed in claim 1,
characterized by
an optical detection of the material to be cut, which detects the material to be cut upon exiting the cutting chamber (3).

11. The material shredder (1) as claimed in claim 1,
characterized by
an acoustic sensor which detects sound oscillations caused when a cutting blade (11) moves past a counter blade (23), wherein the sound oscillations serve to determine the wear on the cutting blades (11).

12. The material shredder (1) as claimed in claim 1,
characterized in that
a counter blade (23) is releasably fixed in a blade holder disposed on the stator (20), wherein the blade holder is movable relative to the cutting head (10) in such a manner
that the counter blades (23) are able to be brought closer to the cutting circumference in an infinitely variable manner.

13. The material shredder (1) as claimed in claim 1,
characterized in that
a blade holder, which is disposed on the stator (20), has blade seats for a plurality of counter blades (23), and
in that the blade holder is rotatably mounted.

14. The material shredder (1) as claimed in claim 1,
characterized by
a suction device which for a suction effect acts on the cutting chamber (3) through the outlet (22).

15. A shredding plant (100), in particular for shredding recyclable material to be cut, having a shredding device, and having a feeding apparatus (2) which is specified to feed material to be cut to the shredding device,
characterized in that
the shredding device is a material shredder (1) as claimed in one of the preceding claims.

16. The shredding plant (100) as claimed in claim 15,
characterized by
a metering device which opens into the feeding apparatus (2) and is specified to introduce a metered quantity of material to be cut into the cutting chamber (3).

17. The shredding plant (100) as claimed in claim 15,
characterized by
a conveyor apparatus which forms a conveying section, wherein the conveying section opens into the feeding apparatus (2) and/or the metering device.

18. A maintenance method for a material shredder (1), comprising the following method steps:
a) radially actuating a grinding medium toward a cutting blade (11) which is disposed on a rotatably mounted rotor, referred to as a cutting head (10), of a material shredder (1), in such a manner that the grinding medium for a grinding effect is brought to engage with a cutting edge (12) of the cutting blade (11);
b) guiding the grinding medium for a grinding effect along the cutting blade (11), wherein the cutting head (10) rotates in the process;
c) radially actuating a screen (24), which is disposed in an outlet (22) of the stator (20), in such a manner that the radial spacing of the screen (24) from a cutting blade (11) is reduced.

19. The maintenance method as claimed in claim 18,
characterized by
d) radially actuating a counter blade (23) which is disposed on a rotor housing, referred to as a stator (20), surrounding the cutting head (10), in such a manner that the radial spacing between the cutting blade (11) and the counter blade (23) is reduced.

20. The maintenance method as claimed in claim 18,
characterized in that
the method steps are feedback-controlled by a control unit.
